(19) United States
(12) Patent Application Publication
(10) Pub. No.: US 2015/0142641 A1
(43) Pub. Date: May 21, 2015

(54) Method of Generating Physical Mail from Electronic Messages

(71) Applicant: Freddie M. Blue, Elizabeth, NJ (US)

(72) Inventor: Freddie M. Blue, Elizabeth, NJ (US)

(21) Appl. No.: 14/083,775

(22) Filed: Nov. 19, 2013

(51) Int. Cl. G07B 17/00; H04L 12/58

(52) U.S. Cl. CPC G07B 17/00508; H04L 51/28; G07B 2017/00516; G07B 2017/00145
USPC 705/39; 709/206

(57) ABSTRACT

A system for transmitting user messages to a recipient via standard physical mail is disclosed. A data service provided over the Internet or other data network receives a message, addressee information, and payment from a user via a network-enabled device such as a personal computer or smartphone. The system generates a postal media item, such as a letter or postcard, from the electronic message. The system applies proper postage and addressee information to the postal media item and deposits it in the mail with the postal authority.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to electronic messaging systems, and in particular to messaging systems that convert electronic messages into physical postal messages. Electronic messaging is enabled today over many different electronic media, but some potential recipients of messages still require or prefer physical mail. To enable sending messages to such individuals, a data service might provide a system for converting electronic messages into postal media items for physical delivery to a recipient.

### SUMMARY OF THE INVENTION

Accordingly, the invention is directed to a system for transmitting user messages to a recipient via standard physical mail. A data service provided over the Internet or other data network receives a message, addressee information, and payment from a user via a network-enabled device such as a personal computer or smartphone. The system generates a postal media item, such as a letter or postcard, from the electronic message. The system applies proper postage and addressee information to the postal media item and deposits it in the mail with the postal authority.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawing is included to provide a further understanding of the invention and is incorporated into and constitutes a part of the specification. It illustrates one embodiment of the invention and, together with the description, serves to explain the principles of the invention.

FIG. 1 is a flowchart displaying the system components and electronic processes and their interconnections, and other relevant events during the course of using the invention.

### DETAILED DESCRIPTION OF THE INVENTION

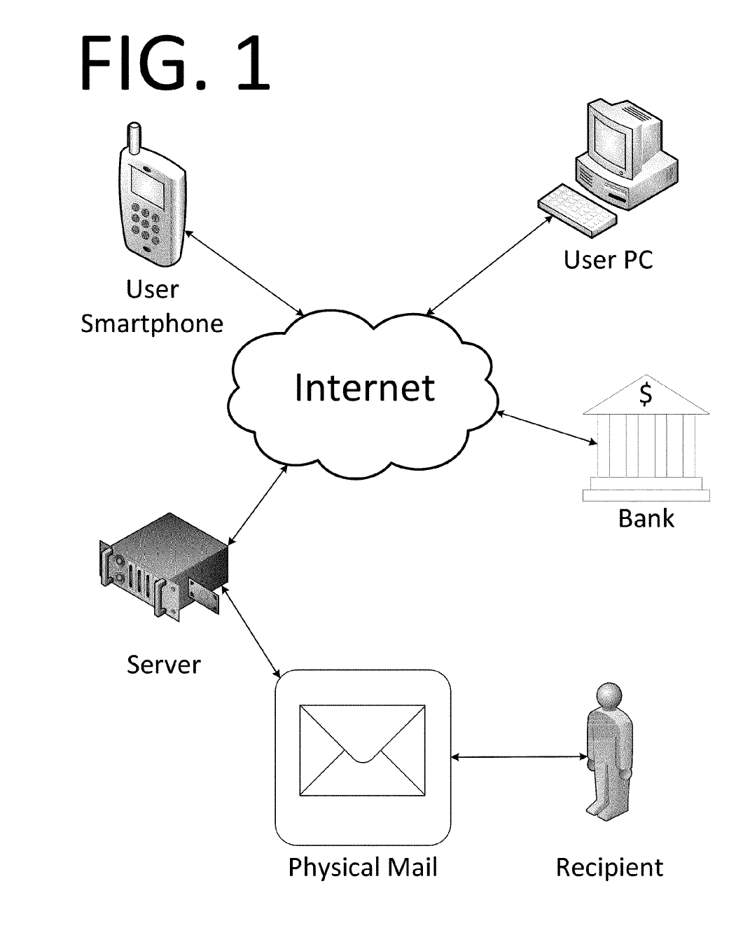

Referring now to the invention in more detail, the invention is directed to a method of generating physical postal messages from electronic messages. FIG. 1 shows a diagram of the first exemplary embodiment. In the first exemplary embodiment, a user having access to an electronic data network, for example the Internet, through a personal computer, smartphone, or other device provides a message and postal addressee information to a server to be transmitted through standard physical mail. The message itself may consist of textual data only, or may be comprised of rich text, graphics or any combination of the two. Further, software running on the server may provide facilities for the user to upload a completed message that the user has prepared using provided software, or may provide facilities for the user to generate a rich textual and graphical message directly through interactions with the server. Plain text data may be converted into rich text or graphics for transmission in the mail according to a template, which may be provided by the user or by the service implementing the invention. In addition to rich textual and graphical data, audiovisual data may also be accepted. Software supporting such activities is well-known in the prior art.

The system provides secured access via a user-generated username and password. A first name, last name, and valid e-mail address will be required from the user. The e-mail address may be used as the username. The system will require address details for delivery of the message. The system may offer a plurality of templates, including a plurality of postcard templates, for the user to employ when composing a message. The system may also offer a selection of fonts, sizes, type colors, and background colors for the message. The system will offer the option to attach one or more images with the message.

Upon receiving a completed message, the system calculates the required postage and service fees. Postage fees may vary depending upon the source and destination country, postal zone, and type of media to be mailed. For example, where a message is formatted with graphical or rich text data on two sides of a card, a post card may be generated, but where one or more full sheets of paper are provided, a letter and envelope may be generated. If the message contains audiovisual materials, a digital representation may be loaded onto digital media such as an optical disc or flash memory card, or alternatively loaded onto a one-time use media playback device, which may or may not also contain rich text or graphical data. An audio greeting card is one example of a one-time use media playback device combined with rich text and graphical information.

The system uses an administrative panel to display the message as composed by the user, and the calculated postage and service fees. The system also stores the message in a database with other messages prepared by the user. The user may elect to send the message, modify or correct the message, or delete the message. If the user elects to modify or correct the message, this may cause a recalculation of the postage and service fees, and the new postage and fees will be displayed with the modified or corrected message.

If the user elects to send the message, the user provides payment from a bank account, credit card, or online payment service, and the server generates a postal media item by printing the message or otherwise generating the physical media of the message along with any required envelope and postage. The process for generating the postal media item may be entirely automated or may require one or more steps performed by a human worker. The system provides postal payment either immediately and electronically or by an account arrangement with the postal authority in the country where the invention is implemented. The generated, assembled, and paid postal media item is then deposited with the postal authority for delivery the designated addressee.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system for generating physical postal messages from electronic messages, comprising:
(a) a mobile application or computer program;
(b) said mobile application or computer program being downloaded or installed within the user's computer, smartphone, or other personal electronic device;
(c) said mobile application or computer program being connected with a server via the Internet or other electronic data network; and
(d) said server being connected automated or human-operated equipment for printing, assembling, and affixing postage to a message generated by a user;
whereby data inputs and selections made via said mobile application or computer program would cause said server to activate the gathering, processing, and display of text, graphics, and image components of the message, via an administrative panel.

2. The system of claim 1 wherein said server provides server software which offers a user facilities to upload a completed message that the user has previously prepared, using said mobile application or computer program, or other media.

3. The system of claim 2 wherein said server software offers a user a selection of message templates, fonts, print colors, background colors, and other components to generate a rich textual and graphic message directly through interactions with said server.

4. The system of claim 3 wherein said server accepts image, audio, video, and data files uploaded by a user for inclusion in a physical postal message, and downloads said image, audio, video, and data files to an optical disc, flash memory card, one-time use media playback device, or other appropriate digital media at the direction of the user.

5. The system of claim 3 wherein said server software calculates the postage and service fees required for preparation and delivery of said physical postal message, and displays said postage and service fees on said administrative panel.

6. The system of claim 5 wherein, upon receiving a completed electronic message and electronic approval of said postage and service fees by a user, said server software accepts payment from the user via electronic funds transfer, credit or debit card, online payment service, or other electronic payment medium, and causes printing, assembly, and the affixing of proper postage, for a physical postal message derived from said electronic message and files provided by the user.
